(19) United States
(12) Patent Application Publication
(10) Pub. No.: US 2014/0012517 A1
(43) Pub. Date: Jan. 9, 2014

(54) Structural damage estimation based on measurements of rotations

(71) Applicant: The Board of Trustees of the Leland Stanford Junior University, Palo Alto, CA (US)

(72) Inventors: Allen Cheung, Stanford, CA (US); Garo Kiremidjian, Los Altos, CA (US); Pooya Sarabandi, Menlo Park, CA (US); Anne S. Kiremidjian, Los Altos Hills, CA (US)

(21) Appl. No.: 13/936,164

(22) Filed: Jul. 6, 2013

Related U.S. Application Data
(60) Provisional application No. 61/668,989, filed on Jul. 6, 2012.

(51) Int. Cl. G01N 19/00

(52) U.S. Cl. CPC G01N 19/00
USPC 702/34

(57) ABSTRACT

Structural damage to a building is assessed based on measurement of point rotations using MEMS accelerometer sensors attached to structural columns of a building. The measured point rotations are wirelessly transmitted to a central unit which estimates residual drifts of the structural columns using a model of plastic deformation of the columns that incorporates empirically predetermined structural parameters of the columns such as a height of a column plastic bending point or a column curvature coefficient. The structural damage to the building is then estimated by determining a damage state from performance-based earthquake engineering performance thresholds that relate residual drift to damage. In some embodiments, multiple sensors are attached to each structural column of the building and measure corresponding point rotations at multiple points along the height of the column.

### CROSS-REFERENCE TO RELATED APPLICATIONS

This application claims priority from U.S. Provisional Patent Application 61/668989 filed Jul. 6, 2012, which is incorporated herein by reference.

### STATEMENT OF GOVERNMENT SPONSORED SUPPORT

This invention was made with Government support under contract 0800932 awarded by National Science Foundation. The Government has certain rights in this invention.

### FIELD OF THE INVENTION

The present invention relates generally to systems and methods for assessing structural damage to buildings. More specifically, it relates to techniques for real-time structural assessment of building damage.

### BACKGROUND OF THE INVENTION

Structural health monitoring (SHM) is emerging as an important field in reducing the seismic hazard to civil structures.

Currently there are no sensors or monitoring systems that provide near real time damage information on a structure subjected to a severe earthquake. The majority of structural monitoring systems measure the response of the structure and then a lengthy analysis is performed off site after the data are collected and transferred to identify hidden damage. Most frequently, damage occurrence is hypothesized after visual inspection by a facilities manager followed by a more detailed investigation by a structural engineer. Typically it takes days, if not weeks, for all the structures to be inspected by an engineer. While waiting for such inspection, the structure may be unnecessarily closed or may be critically damaged yet open for use, potentially resulting in injuries and deaths from collapse.

SHM systems can support the response to earthquakes in the following ways. Immediately following a large earthquake, information obtained from the SHM system can be rapidly transmitted to decision-makers in order to assist in the deployment of emergency response crews and to determine whether critical structures (e.g. bridges, hospitals) can remain operational. This rapid compilation of structural health information may significantly reduce the seismic hazard due to aftershocks. Later, SHM systems can augment traditional site inspections in order to help make the appropriate repair or occupancy decision.

In order for an SHM system to have widespread deployment, it needs to be robust and inexpensive. Robustness is achieved by selecting a damage measure (DM) that is well correlated with seismic damage. One common metric for seismic damage to civil structures is the residual drift ratio. Large residual drifts (permanent displacements) are indicative of structural damage; furthermore the residual drift itself weakens the structure through the gravity force and displacement effect known as P-4 effect. Identification of permanent drift is one of the first steps in preliminary post-earthquake building inspection, and residual story drift can be used to determine the damage state of frame structures. Unfortunately, typical methods of directly measuring drift are expensive and suffer from several disadvantages. Use of global positioning systems for direct displacement measurement is expensive and is limited by the need for a direct line of sight to the satellite. Laser interferometry methods for direct displacement measurement are limited in only being able to measure relative displacement. Moreover, these techniques are difficult to apply to wide variety of structures. In addition, both are limited to measuring displacements on the exterior of the structure.

### SUMMARY OF THE INVENTION

In one aspect, the invention provides a method for assessing structural damage to a building. Multiple sensors attached to structural columns of the building measure corresponding point rotations. Each point rotation is measured relative to gravity and derived from measured acceleration magnitudes along the axes of a multi-axis micro-electro-mechanical systems (MEMS) accelerometer. The measured point rotations are wirelessly transmitted by the multiple sensors to a central unit that estimates from the measured point rotations corresponding residual drifts of the structural columns using a model of plastic deformation of the columns. The structural damage to the building is estimated from the estimated residual drifts by determining a damage state from performance-based earthquake engineering performance thresholds that relate residual drift to damage.

In one embodiment, the plastic deformation model used to estimate the residual drifts of the structural columns incorporates empirically predetermined parameters of the columns, such as heights of the columns over which the columns do not deflect or an empirical correction factor to correct for column curvature.

The measurement of the point rotations by the multiple sensors may be performed at scheduled intervals or immediately after a strong motion is detected by the sensors. The measurement of the point rotations preferably includes calculating by the multiple sensors corrected point rotations using initial point rotations stored by the sensors. In some embodiments, multiple sensors are attached to each structural column of the building and measure corresponding point rotations at multiple points along the height of the column. In embodiments where multiple sensors are attached to each column, the residual drifts may be estimated from the measured point rotations by estimating the curvature along the length of the column from the measured point rotations, e.g., by fitting a polynomial to the measured rotations and integrating the polynomial. Embodiments may also encompass sensors attached to structural beams, and corresponding measurement of point rotations of the beams.

### BRIEF DESCRIPTION OF THE DRAWINGS

FIG. 1 is an outline of main steps of a real-time method for assessing structural earthquake damage to a building according to an embodiment of the invention.

FIG. 2 is a schematic block diagram providing an overview of a structural health monitoring system implementing the method of the present invention.

FIG. 3 is a schematic block diagram of a sensor 300 used in a structural health monitoring system according to an embodiment of the invention.

### DETAILED DESCRIPTION

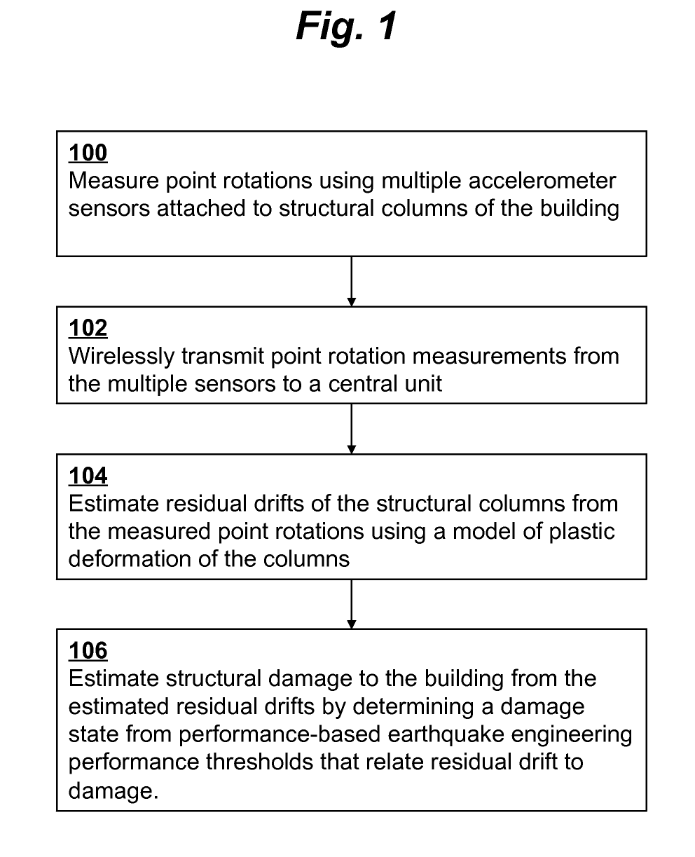

FIG. 1 is an outline of main steps of a real-time method for assessing structural earthquake damage to a building according to an embodiment of the invention. In step 100, multiple sensors attached to structural columns of the building measure corresponding point rotations. Each point rotation is measured relative to gravity and derived from measured acceleration magnitudes along the axes of a multi-axis electro-mechanical systems (MEMS) accelerometer. The measured rotations are preferably corrected using initial calibrated rotation values stored in the sensors after installation in the building. In step 102, the measured point rotations are wirelessly transmitted by the multiple sensors to a central unit. In step 104, the central unit estimates from the measured point rotations corresponding residual drifts of the structural columns using a model of plastic deformation of the columns. In step 106, the structural damage to the building is estimated from the estimated residual drifts by determining a damage state from performance-based earthquake engineering performance thresholds that relate residual drift to damage.

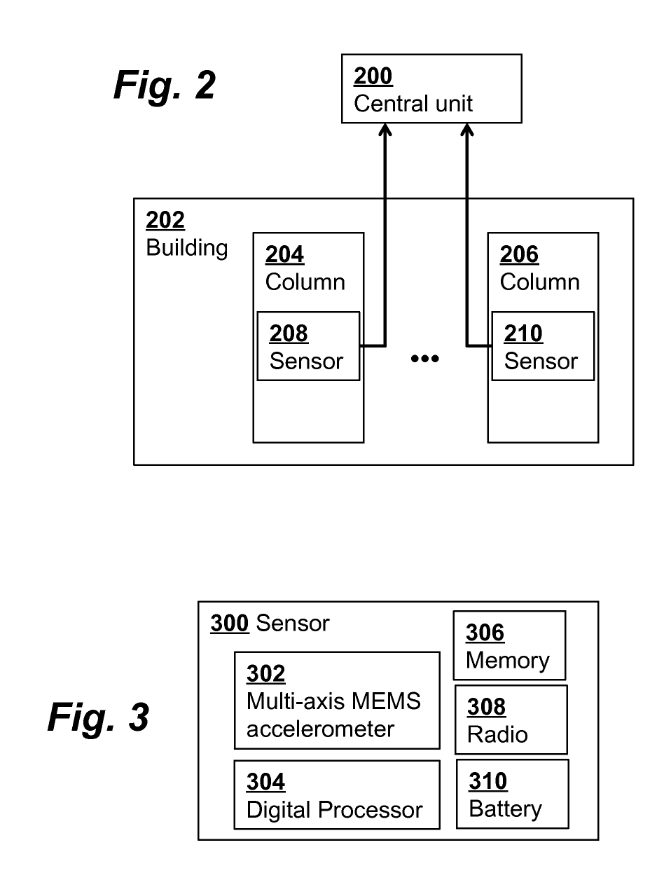

FIG. 2 is a schematic block diagram providing an overview of a structural health monitoring system implementing the method of the present invention. It includes a central unit 200 and multiple sensors 208 through 210 attached to columns 204 through 206 of a building 202. The columns are preferably on both the exterior and the interior of the building, and can thus obtain measurements in the exterior and the interior members of the structure and provide information on a more localized level than prior approaches.

In one embodiment, the sensors are preferably attached near the top or bottom of the columns. These locations are preferably just outside of estimated plastic hinge lengths measured from the bottom and/or the top of columns. In some embodiments, to improve accuracy, multiple sensors may be attached to each structural column of the building and measure corresponding point rotations at multiple points along the height of the column. The method of the invention, however, has the advantage that it provides reasonable drift estimates even with a single sensor attached to each column. Embodiments may also encompass sensors attached to structural beams, and corresponding measurement of point rotations of the beams. The columns may be on a single story of the building or on multiple stories. Sensors 208 through 210 communicate wirelessly with central unit 200 over wireless data communications links, as shown. The wireless link may be direct or indirect via multiple intermediate communication links.

FIG. 3 is a schematic block diagram of a sensor 300 used in a structural health monitoring system according to an embodiment of the invention. It includes a multi-axis MEMS accelerometer 302, digital processor 304, memory 306, radio 308, and battery 310. MEMS accelerometers offer several advantages over other rotation sensors: (1) they are low cost compared to alternatives (such as gyroscopes), (2) they can be made robust to shock and high g loads (such as those as a result of an earthquake), and (3) the functionality of an accelerometer allows a number of other uses, such as recording the structural response or detecting the presence of an earthquake. Although MEMS accelerometers can detect that an earthquake or other major event has occurred, they typically are unable to measure precise dynamic rotation (i.e., rotation during a strong earthquake motion itself) and therefore the present method is focused on estimating residual drift after the major motion has stopped.

Selection of the type of MEMS accelerometer 302 depends on the desired rotation measurement resolution, which can be determined from the smallest value of residual drift that is desired for the measurement. Residual drift thresholds for damage states provide a method of selecting the desired resolution. One example of a residual drift guideline is FEMA 356, which provides residual drift thresholds for three damage states: collapse prevention, life safety, and immediate occupancy (FEMA 356). The threshold for entering the life safety damage state is 1% story drift ratio (SDR) for concrete and steel moment resisting frames and 0.5% SDR for steel braced frames. The story drift ratio (SDR) is defined as the ratio of the residual displacement to the height of the column. Thus, detection of at least 0.5% SDR is necessary in order to detect the second damage state. Typically, however, greater resolution would be desired in order to more precisely determine the amount of damage. One possible target is 0.5% SDR resolution. To be able to estimate SDR of 0.5% the accelerometer has to measure a minimum of 5.1 mg in the horizontal direction. Accelerometers with a signal to noise ratios of 2.5 or smaller can readily provide the accuracy necessary for these small rotations and corresponding residual displacements.

For the purposes of wireless SHM, it is important to ensure that the tasks performed and data transmitted by the wireless sensing unit 300 are minimal. By performing low pass filtering and rotation calculations on board the sensor with the sensing unit microprocessor 304, only the resulting residual rotation values need to be transmitted wirelessly, rather than an entire acceleration data stream. This conserves battery power and reduces the need for frequent sensor maintenance. Additionally, because these sensors are inexpensive and convenient to install, it is practical to use them for widespread and dense deployment throughout a building.

Returning now to FIG. 1, step 100 is performed in parallel by the set of sensors that have been installed in a building. The rotation measurements after a major event are preferably made by correcting a current measurement with an initial measurement made by the sensor after it was initially installed in the structure. The initial static acceleration measurements at each sensor node are recorded and stored in the sensor during this initial calibration procedure. For each sensor, these initial measurements represent the acceleration magnitudes along the axes of the accelerometer at locations of the sensors.

Use of MEMS accelerometers to measure orientation with respect to gravity is well-known, and a full description of the procedure is available in datasheets from MEMS manufacturers. For the present purposes, an important characteristic of MEMS accelerometers is that they are capable of measuring DC (zero frequency) accelerations, and consequently the accelerometer measures the force of gravity acting on the sensor. This makes it possible to calculate the rotational orientation of the sensor relative to the direction of gravity by measuring the magnitude of acceleration along each axis of the sensor. Specifically, assuming that two axes of the MEMS accelerometer are orthogonal to each other, the initial angle θ₀ is related to the measured acceleration magnitudes x₀, y₀ along each axis by tan θ₀=(y₀/x₀). The angle θ₀ and/or the pair of magnitudes (x₀,y₀) are then stored in the memory of the sensor.

During later operation, rotation measurements are again taken at each sensor node installed on the structure, producing a current angle θ corresponding to a current pair of magnitudes (x,y), related by tan θ=(y/x). These measurement may be performed at scheduled intervals or immediately after a strong motion is detected by the sensors. In one embodiment, the sensors are normally in a sleep mode in which they take periodic measurements at very low sampling rate and monitor these for a strong motion. Since earthquake vibrations gradually increase in amplitude, a strong motion event is detected when the amplitude is greater than a predetermined threshold, say 0.01 g. The sensor then wakes up from a low-power mode and, after the vibrations stop, measures the rotation values. Other, more sophisticated wake-up algorithms may be used to help insure that the motion actually represents an earthquake instead of a spike caused by forces other than earthquakes.

The initial calibrated measurements are recalled from memory at this time to correct for the initial rotation bias. Performing a correction relative to the initial calibrated values has the advantage that the sensors need not be precisely aligned with gravity during installation. According to one embodiment, the correction is performed by simply subtracting the initial rotation angle θ₀ stored at each sensor from the current measured angle θ, thereby producing the rotation of the sensor since the sensors were initially installed on the structure. For simplicity of notation, the corrected measurement of the rotation angle is henceforth referred to as θ, i.e., the angle measured by the sensor is assumed henceforth to be the corrected angle. According to another embodiment, the correction is performed by calculating the angle between the vectors (x₀,y₀) and (x,y) using the definition of the dot product, i.e., cos θ=(x₀,y₀)·(x,y)=x₀ x+y₀ y. This approach stores the initial vector (x₀,y₀) instead of the initial angle θ₀ and involves one calculation of the arccosine instead of two calculations of the arctangent.

Preferably, the accelerometer magnitudes are low-pass filtered (e.g., with a 30 Hz cut-off) or averaged by the sensor's digital processor to eliminate high frequency ambient vibrations, since only the constant DC values are of interest for this application.

Preferably, to reduce the effects of MEMS measurement noise, the accelerometer magnitudes are sampled repeatedly to produce an average result whose error is sufficiently small to provide rotation values within desired tolerance. For example, using a commonly available accelerometer with noise of 0.0028 g, a 95% confidence in drift measurement is obtained by taking 500 samples. At a sampling rate of 100 Hz, sampling is performed for 5 seconds. More preferably, however, 5000 samples are taken to provide higher accuracy of the final estimation.

As shown in step 102, after measurement of its rotation angle, each sensor 208 through 210 wirelessly transmits its measured point rotation angle θ to the central unit. The transmission may be done periodically, or in response to a large motion event detected by the central unit 200. Rotation measurements are received by the central unit from the sensors 208 through 210 installed in the building. These measurements may be denoted as an n-dimensional vector θ, where the components correspond to the rotation angles received from n sensors installed in the building.

Having received the rotational angles θ from the sensors in the building, the central unit then proceeds to perform a damage diagnosis in two steps, 104 and 106.

In step 104, the rotation measurements collected by the central unit 200 from all the sensors 208 through 210 are used by the central unit to estimate the residual drift of each of the columns 204 through 206. For multistory structures, these can be combined to estimate story drifts at each floor. In the case of a single column or bridge column, this step estimates from the rotation measurement the drift at the top of the column. To reduce sensor density and overall system cost, often only one point rotation measurement will be available at each column. An approximate estimate of the residual drift Δp could be calculated based on a simple linear model that assumes the column bends at its base under a lateral load and otherwise remains straight. In this case, the residual drift Δp is related to the measured rotation angle θ for the column by Δp=h tan θ, where h is the height of the column. This naïve model is based on the following assumptions: (1) the column is modeled as a line element and the plastic hinge takes place at a single point at the base of the column and (2) the plastic rotation θ is constant along the length of the column. Because these assumptions are only approximately valid, however, this model results in inaccurate estimates of the drift. In reality, the plastic hinge will occur over a region of the column, and some slight permanent curvature may occur. Consequently, the naive model will overestimate the actual amount of drift present by nearly 30%.

The present invention significantly improves the accuracy of the drift estimate (reducing error by more than 50%) as compared to the linear model estimate by using more realistic models that do not assume linearity along the entire length of the column and that incorporate empirically predetermined structural parameters of the column. The models were experimentally tested by the inventors using circular reinforced concrete columns, and they were confirmed to increase significantly the accuracy of the drift estimates.

In one embodiment, the drift is estimated based on a model in which the plastic hinge is not located at the base of the column but instead at some length L above the base of the column. In other words, the plastic deformation model used to estimate the residual drifts of the structural columns incorporates empirically predetermined heights of the columns over which the columns do not deflect. The model in this case assumes that the columns hinge at the predetermined heights and assumes a rotation of the residual portions of the columns. In this piecewise linear model, the column does not deflect or bend above or below the bending point located at height L above the base. In this case, the residual drift Δp is related to the measured rotation angle θ for the column by Δp=(h−L) tan θ. An appropriate value for L is empirically predetermined using experimental tests or detailed computational models of the particular column based on its structural and material properties. For example, 1.62 m tall, 41 cm diameter circular reinforced concrete columns may have an empirically determined value for L of approximately 38 cm. The value for L may be experimentally determined in a shake test experiment by directly measuring the height h of the column, the drift Δp at the top of the column using displacement transducers, measuring the rotation angle θ near the top of the column directly using a MEMS accelerometer as described earlier or indirectly by combining the measured drift at the top of the column with a drift measured at a second displacement transducer below the first, and solving the above equation for L.

In an alternative embodiment, the drift is estimated based on a model in which residual curvature is modeled along the length of the column using an empirical correction factor C that is constant for all columns of the same type. In other words, the plastic deformation model used to estimate the residual drifts of the structural columns incorporates empirically predetermined column curvature coefficients. The model in this case assumes rotations of the entire lengths of the columns and corrects resulting drifts using the empirically predetermined column curvature coefficients. In this case, the residual drift Δp is related to the measured rotation angle θ for the column by Δp=C h tan θ. The value of C is empirically predetermined using experimental tests or detailed computational models of the particular column based on its structural and material properties (e.g., column size, material, and detailing). For example, circular reinforced concrete columns may have an empirically determined value for C of approximately 0.9. The value for C may be experimentally determined in a shake test experiment by directly measuring the height h of the column, the drift Δp at the top of the column using displacement transducers, measuring the rotation angle θ near the top of the column directly using a MEMS accelerometer as described earlier or indirectly by combining the measured drift at the top of the column with a drift measured at a second displacement transducer below the first, and solving the above equation for C. Multiple shake tests may be determined and the results may be used to determine a value for C that fits the data in the least squares sense.

Although the examples above are specific to concrete columns, application to steel structures and frame structures is easily performed using the same methodology, where minor changes may be necessary (in particular, frame columns will form a plastic hinge at the top of the column as well as at the base). At near-collapse damage states, the models may break down as the plastic hinge region increases and exhibits curvature. However, at such large damage states, accuracy is much less of a concern because slight changes in the estimated drift will not affect the damage decision.

Following the displacement estimation in step 104, the next step 106 is to classify the damage state of the structure. An advantage of the present approach SHM is that robust relationships between residual drift and damage have been developed from the field of performance based earthquake engineering (PBEE) in the form of performance thresholds. The goal of performance thresholds in PBEE is to establish objectives for structural design. In embodiments of the present invention, on the other hand, thresholds are used as damage state classifiers in SHM. Typical performance thresholds are displacement based, and although maximum transient inter-story drift ratio is one of the more common parameters, relationships between residual drift and damage have also been developed. Damage estimation may thus be correlated to residual drift using structural performance data of the structural system.

Table 1 presents an example of a damage table for residual drift, summarizing FEMA 356 Table C1-2. The table defines three damage states and sets residual drift thresholds for each state. For SHM purposes, the drift estimates obtained from the rotation algorithm can be compared with the table to classify the damage state of the structure. The damage state of the structure is governed by the maximum story drift along all stories. The maximum story drift is then related to damage state of the structure. The story with the maximum story drift is also indicative of the most likely location the largest amount of damage.

TABLE 1
Classification of damage states based
on permanent drift from FEMA 356

| | Structural Performance Level: | | |
|---|---|---|---|
| | Permanent Interstory Drift | | |
| | Collapse | | |
| Structural System | Prevention | Life Safety | Immediate Occupancy |
| Concrete Frames | 4% | 1% | negligible |
| Steel Moment Frames | 5% | 1% | negligible |
| Steel Braced Frames | 2% | 0.50% | negligible |

Once the damage state of a building has been determined, the central unit (e.g., an internet server) can make this information available for access to appropriate personnel and systems. This information can be of critical importance for evacuating a structure that is critically damaged, or can help owners make decisions on relocation of resources or operations if the damage is serious. By making information on the degree of damage available within a short period of time, not only rapid response for evacuation can be initiated, but also appropriate decisions for repair can be made in a timelier manner. The invention also has application to residential homes. For example, a simple low-cost acceleration sensor can be used in single family home that can signal an alarm if the home is in serious damage state, thus preventing or minimizing casualties. In such an embodiment, the drift and damage steps 104 and 106 could be integrated into the sensor device itself 208 instead of on a separate central unit 200.

The method of the present invention enables direct estimation in near real time after an earthquake of the extent of damage that may have occurred to a structure. The technique is applicable to a very wide variety of structural types and thus can be a very effective method for early damage information delivery. The techniques of the present invention can be applied to buildings, bridges, electrical towers, wind turbines, structures in industrial facilities such as oil refineries and chemical plants, and any other elevated structure. In addition to earthquakes, the present method can also be used for assessing structural damage to structures subjected to strong wind or sea waves. For example, a wind energy provider can use the method assess damage to wind towers subjected to strong wind and sea waves.

Various alternate embodiments of the invention include using multiple rotation sensors attached to each column. While the use of additional sensors attached to each column increases the expense of the system, using multiple sensors per column provides greater accuracy. In this case, sensors are preferably placed near the top and bottom of the column. More generally, they are preferably placed near but outside of the expected plastic hinge locations. Plastic hinge locations are typically at the top and/or the bottom of columns. Plastic hinge lengths depend on the size of the column and can be roughly estimated from the geometry and the material properties of the columns. Thus, the locations of the sensors are preferably close to the ends of the columns but far enough to avoid being right at the locations of plastic hinge formation. To increase accuracy more, preferably three sensors are used. For yet more accuracy, four sensors are preferred. If more than two sensors are used, at least one of the additional sensors is preferably positioned in close proximity to the top or bottom sensors. An optimal number of sensors to balance the tradeoff of accuracy and expense is four sensors per column, although three sensors and two sensors per column also provide noticeable improvement over just one. In other alternate embodiments, inertial sensors may be combined with accelerometers to obtain more direct displacement measurements.

The use of multiple sensors per column is preferably used to estimate the curvature of the column, leading to a greatly improved estimate of the permanent deformation and resulting damage. The residual displacement, for example, may be estimated by first fitting an analytical curve (preferably a polynomial) to the tangent of the rotation measurement angles as a function of sensor position along the length of the column.

Because the tangent of the rotation angles represents the slope of the curved column, integrating the analytical curve fit to the measured points produces a curve estimating the column curvature, and hence the displacement. The constant of integration is determined from the constraint that the bottom of the column remains fixed. Preferably, the analytical curve used for the fit to the rotation measurements is a (k−1)-th order polynomial, where k is the number of sensors on the column. Integration thus yields a k-th order polynomial fit to the column curvature.

1. A method for assessing structural damage to a building, the method comprising:
measuring by multiple sensors attached to structural columns of the building corresponding point rotations, wherein each of the multiple sensors measures a point rotation relative to gravity derived from measured acceleration magnitudes along each axis of a multi-axis micro-electro-mechanical systems (MEMS) accelerometer;
wirelessly transmitting by the multiple sensors to a central unit the corresponding point rotations;
estimating by the central unit from the measured point rotations corresponding residual drifts of the structural columns using a model of plastic deformation of the columns; and
estimating structural damage to the building from the estimated residual drifts by determining a damage state from performance-based earthquake engineering performance thresholds that relate residual drift to damage.

2. The method of claim 1 wherein the model incorporates empirically predetermined heights of the columns over which the columns do not deflect.

3. The method of claim 1 wherein the model incorporates empirically predetermined correction factor that corrects for column curvature.

4. The method of claim 1 wherein measuring by the multiple sensors the corresponding point rotations comprises calculating corrected point rotations using initial point rotations stored by the multiple sensors.

5. The method of claim 1 further comprising measuring by multiple sensors attached to structural beams of the building corresponding beam point rotations.

6. The method of claim 1 wherein each of the multiple columns has more than one sensor attached.

7. The method of claim 1 wherein estimating the residual drifts comprises estimating, for each column, a curvature along a length of the column from multiple point rotations measured by multiple sensors attached to the column.

8. The method of claim 7 wherein estimating the curvature comprises fitting a polynomial to the multiple point rotations and integrating the polynomial

9. The method of claim 1 wherein measuring by multiple sensors is performed at scheduled intervals or immediately after a strong motion is detected by the sensors.
